(19) United States
(12) Patent Application Publication
(10) Pub. No.: US 2007/0097993 A1
(43) Pub. Date: May 3, 2007

(54) System and method for remote control of local devices over a wide area network

(76) Inventors: Richard D.K. Bojahra, Uxbridge (CA); Byron A.P. Hurn, Newmarket (CA); Mark J. Borins, Toronto (CA); Alireza Motamed, Toronto (CA)

Correspondence Address: Gowling Lafleur Henderson LLP;1 First Canadian Place, Suite 1600, 100 King Street West, Toronto, ON, M5X 1G5, CA

(21) Appl. No.: 11/263,849

(22) Filed: Nov. 2, 2005

(51) Int. Cl. H04L 12/56

(52) U.S. Cl. 370/401

(57) ABSTRACT

A system and method for remote monitoring via an external network of the operation of a plurality of devices located on a local area network. The system and method comprise a gateway device, such as a server or intelligent router, for coupling the external network with the local area network. The gateway device has a unique external network address and is configured for receiving a network data packet addressed by the external network address. The gateway is configured for extracting a device data packet from the network data packet and for sending the device data packet to an associated local network address on the local area network. The system and method also have a control server coupled to the gateway via the external network and configured for generating the network data packet to contain the device data packet associated with a selected device of the plurality of devices. The local network address is associated with the selected device. The system and method also have a controller device located on the local area network and coupled to the selected device. The controller receives the device data packet according to the local network address and is configured to operate the selected device according to the contents of the device data packet.

The present invention relates to control of devices over a network and more particularly to systems and methods for remote control of local devices.

### BACKGROUND OF THE INVENTION

These is an increasing need for coordinated control of sensors and other low data rate devices in a variety of residential and commercial environments. Presently, remote control of sensors such as thermostats and other low data rate devices such as switches for electronic devices is done using local area networks using wireless communication technologies. One example of these local area networks is a network of Zigbee TM controllers, provided by Helicomm, coupled to the devices.

However, the controllers used in current wireless networks operate on a line-of-sight basis and therefore are susceptible to environmental constraints, such as limited transmission distances in the presence of object interference (e.g. building walls), as well as limited scalability due to the restricted number of controllers that can be monitored from a central controller of the local area network.

It is an object of the present invention to provide a remote device control system and method to obviate or mitigate at least some of the above presented disadvantages.

### SUMMARY OF THE INVENTION

Controllers used in current wireless networks operate on a line-of-sight basis and therefore are susceptible to environmental constraints, such as limited transmission distances in the presence of object interference (e.g. building walls), as well as limited scalability due to the restricted number of controllers that can be monitored from a central controller of the local area network. Contrary to current control systems there is provided a system and method for remote monitoring via an external network of the operation of a plurality of devices located on a local area network. The system and method comprise a gateway devicemodule, such as a server or intelligent router, for coupling the external network with the local area network. The gateway has a unique external network address and is configured for receiving a network data packet addressed by the external network address. The gateway is configured for extracting a device data packet from the network data packet and for sending the device data packet to an associated local network address on the local area network. The system and method also have a control server coupled to the gateway via the external network and configured for generating the network data packet to contain the device data packet associated with a selected device of the plurality of devices. The local network address is associated with the selected device. The system and method also have a controller devicemodule addressable on the local area network and coupled to the selected device. The controller receives the device data packet according to the local network address and is configured to operate the selected device according to the contents of the device data packet.

According to a first aspect there is provided a system for remote monitoring via an external network of the operation of a plurality of devices located on a local area network, the system comprising: a gateway module for coupling the external network with the local area network, the gateway module having a unique external network address and configured for receiving a network data packet addressed by the external network address, the gateway module configured for extracting a device data packet from the network data packet and for sending the device data packet to an associated local network address on the local area network; a control server configured for coupling to the gateway module and configured for generating the network data packet to contain the device data packet associated with a selected device of the plurality of devices, such that the local network address is associated with the selected device; and a controller module addressable on the local area network and coupled to the selected device, the controller module for receiving the device data packet according to the local network address and configured for operating the selected device according to the contents of the device data packet.

According to a further aspect there is provided a system for remote monitoring via an external network of the operation of a plurality of devices located on a local area network, the system comprising: a control server having a unique external network address and configured for processing a received network data packet that contains a device data packet associated with a selected device of the plurality of devices; a gateway module configured for coupling to the control server via the external network, the gateway device for coupling the external network with the local area network, the gateway module configured for sending the network data packet to the external network address, the gateway module configured for adding the device data packet to the network data packet prior to sending the network data packet such that the device data packet is associated with a local network address on the local area network, the local network address associated with the selected device; and a controller module addressable on the local area network and configured for coupling to the selected device, the controller for sending the device data packet including the local network address to the gateway device.

According to a further aspect there is provided a method for remote monitoring via an external network of the operation of a plurality of devices located on a local area network, the system comprising: generating a network data packet to contain a device data packet associated with a selected device of the plurality of devices, the network data packet including a unique external network address of a gateway module located on the external network and a local network address associated with the selected device; and sending the network data packet to the gateway module, the gateway module for coupling the external network with the local area network, the network data packet configured for providing the local network address for use by the gateway module for forwarding the device data packet to the selected device.

### BRIEF DESCRIPTION OF THE DRAWINGS

These and other features of the preferred embodiments of the invention will become more apparent in the following detailed description in which reference is made to the appended drawings by way of example only, wherein:

FIG. 1 shows a control system for remote monitoring of device operation;

FIG. 2 shows a local area network of the control system of FIG. 1;

FIG. 3 shows a protocol stack of the local network of FIG. 1;

FIG. 4 shows a gateway of the system of FIG. 1;

FIG. 5 is a further embodiment of the gateway of FIG. 4;

FIG. 6 is an example operation of the system of FIG. 1;

FIGS. 7a,b are a block diagrams of example data packets communicated in the system of FIG. 1; and

FIG. 8 is a further embodiment of the operation of FIG. 6.

### DESCRIPTION OF THE PREFERRED EMBODIMENTS

Control System 10

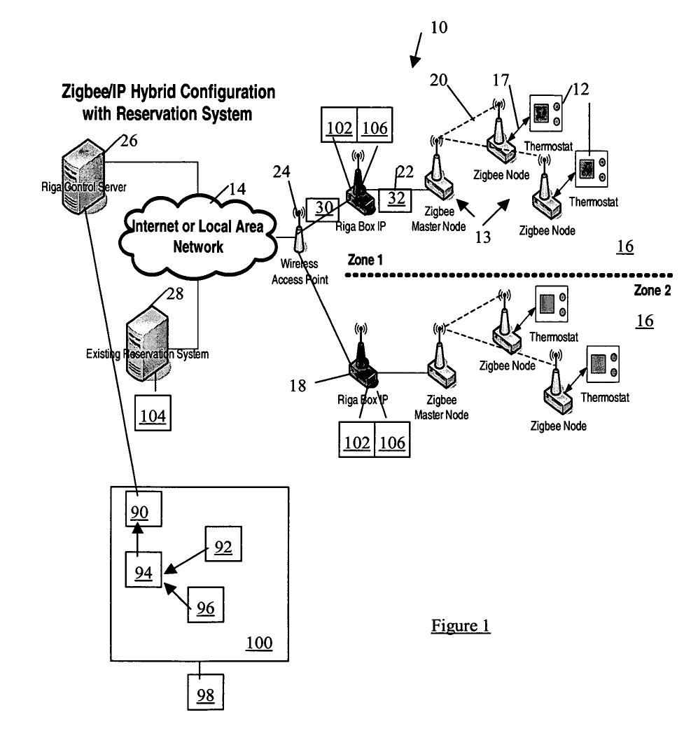

Referring to FIG. 1, a control system 10 is shown for monitoring and controlling the operation of a plurality of devices 12, each connected to a respective device controller 13. The devices 12 can be devices such as but not limited to environmental monitoring instruments, medical and building monitoring instruments, sensors for measuring temperature andor heat flow (e.g. thermostats), and switches for electronic devices (e.g. lights, televisions, appliances, etc. . .). Each of the controllers 13 communicate data to andor from their respective device 12 via a communication link 17, which can be a wired or wireless connection as desired. For example, the communication link 17 can use an RS-232 or RS-485 communication protocol. The communicated data can be data such as but not limited to sensor readings, configuration data, diagnostic data, andor control softwareupdates. The controllers 13 can be collected into groups or zones 16 on a local device network 20, which is coupled via link(s) 22 to a widelocal area network 14 (e.g. the Internet) via a gateway 18. The gateway 18 can be a network device such as but not limited to a server or a router embodied in software, hardware, or a combination thereof. A wireless access point 24 can be used to provide a communication link between the networks 14,20. It is recognised that the networks 14,20 could be coupled via a wired connection instead of the wireless access point 24, as desired. A control server 26 is coupled to the network 14 and is used to monitor the devices 12 of the device network(s) 20.

In one embodiment of the control system 10, a management system 28 such as a reservation management system is accessible by the control server 26 for determining the occupancy/use status of hotel rooms (e.g. physical location), in which at least one of the controllers 13 and respective device(s) 12 (e.g. thermostat) are located. It is recognised that the management system 28 can be for monitoring the status of hotel bookings, conference room usage, or other appropriate status for the physical location of the devices 12. For example, the control system 10 can be a web-based thermostat control system (Internet accessible via network 14) for a network 20 of thermostats (i.e. devices 12) in a complex of buildings (having a plurality of zones 16—e.g. one zone 16 per building or one zone 16 per floor of a building), designed for configuringcontrollingmonitoring the serial capable thermostats (an example of devices 12). The operation of the devices 12 are monitored (e.g. active control andor passive monitoring) through device control software 100 located on the control server 26 andor device control software 102 located on the gateway 18, as further described below. The reservation management system 28 has a database 104 accessible by the software 100,102 for facilitating monitoringcontrol of the devices 12 through their respective controllers 13, the database 104 having data such as but not limited to hotel room occupancy schedule and historical operation data collected from the devices 12 as further described below.

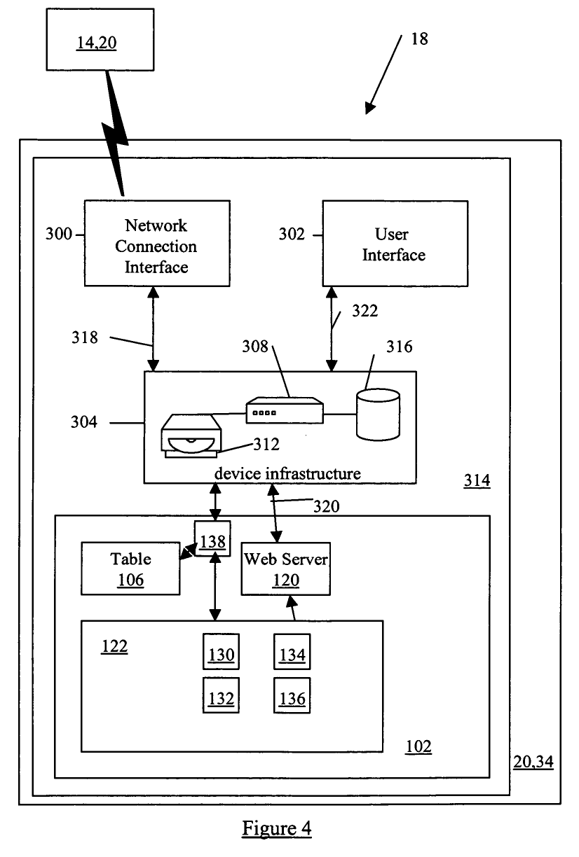

Referring to FIG. 1, control server 26 hardware can have similar components to that of the gateway 18 (see FIG. 4). The software 100 of the control server 26 can have a communication module 90 for sending datainformation requests to the gateway 18 for subsequent transmission to the controllers 13 of the network 20. The module 90 is responsible for wrapping the packet 32 (suitable for transmission over the network 20) inside the packet 30 (suitable for transmission over the network 14). The software 100 also has a configuration module 92 for accessing the reservation system 28 (or other appropriate system) for determining information related to the desired operation of the devices 12 (e.g. room occupancy) including overall status of the physical location and services associated with the physical location (e.g. occupancy of a hotel room, occupancy of areas in a factory such as powering onoff equipment according to shift changes, school portables controlling power and heatingcooling based on class schedules, etc . . .). A control module 94 would have pre-programmed business logic for the operation of the devices 12, which would use as an input the information gathered by the configuration module 92 (e.g. based on updated room occupancy, the module 94 would determine the related device 12 operation required and send the appropriate device 12 configuration informationdatacommands as packet 30 contents via the module 90). The software 100 would also have access to a table 98 having network 14 and network 20 addressing of the gateway 18 and connected controllers 13 for selected devices 12, as identified by the control module 94 (e.g. either automated, semi-automated, or manual). This addressing would be incorporated into the packet 32 and packet 30, as further described below.

The local device network(s) 20 can use for example a Zigbee TM (IEEE 802.15.4) andor Wi-Fi (IEEE 802.11) communication protocols to create a network 20 of HVAC controls and building automationsensors (i.e. devices 12). The network(s) 20 can be extensible and abstracted though coupling to the network 14 (e.g. an IP-based Ethernet network), such that different devices 12 can be monitoredcontrolled from the central control server 26. From the server 26, each of the gateways 18 of the combined network 14,20 is accessible via Internet Protocol (IP) address, such that utilising the IP addressing provides for the server 26 to controlmonitor a largely scaleable network of devices 12 deployed over varying network configurations and controller 13 communication protocols. The IP based protocol is a data oriented protocol used by source and destination hosts (e.g. the control server 26 and the gateway 18) for communicating the data packets 30 across the packet switched inter-network 14. Further, it is recognised that the gateway 18 and controllers 13 can use different networkcommunication protocols directed from the control server 26, such as but not limited to Zigbee 900MHz and 2.4 GHz (IEEE 802.15.4), Wi-Fi (IEEE 802.11), Wired Ethernet (IEEE 802.3), RS-232 , and RS-485, as further described below. The gateways 18 operate as central node control devices that take information in the form of packets 30 from the server 26 intended for the device 12 (via the respective controller 13—e.g. local node control devices) and back. It is recognised that the devices 12 can be thermostats, stressstrain sensors, relay controls, motion sensors, automation controls, and other environmental sensors.

Local Networks 20

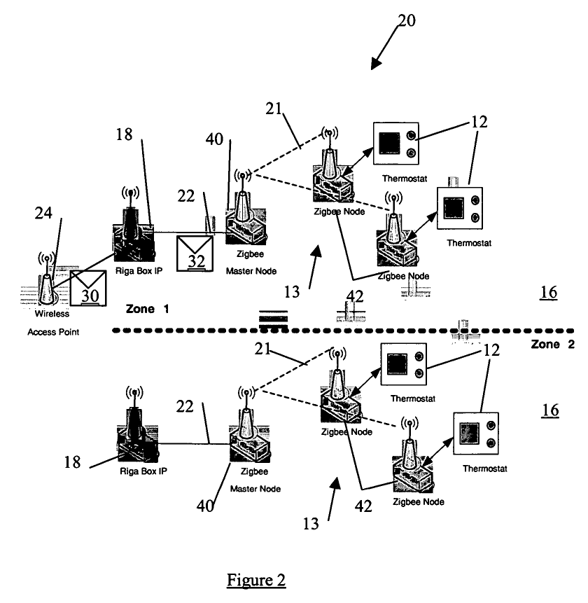

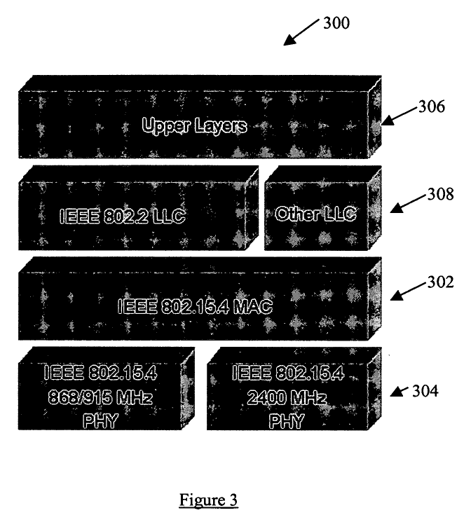

Referring to FIG. 2, the local device network 20 can be a wireless based network based on a network standard such as but not limited to IEEE 802.15.4, 802.11 (wireless Ethernet) or Wired Ethernet, see FIG. 3, with applications targeted toward groups of unattended wireless systems in homes, offices, hotels, and factories. The local network 20 can be designed for use with low power digital radios present in the controllers 13 andor gateways 18. The network 20 can be represented as a cluster of clusters, a mesh, or a single cluster configuration containing a plurality of the controllers 13 and respective devices 12. The network 20 can be designed for low data transmission rates with respect to the requirements of the devices 12. For example, the IEEE 802.15.4 standard for lower layers 302, 304 of a protocol stack 300 of the network 20 supports, low power consumption (e.g. sensor networks) and data rates in the range 20-250 kbps. The stack layer 304 has two physical layers, for example, namely 868 MHz/915 MHz and 2.4 GHz with data rates of and 20/40 kbs and 250 kbs respectively. Further, the network can support low latency devices 12 (e.g. guaranteed time slots in star networks 20), where both star or peer-to-peer network 20 topologies can be used. The network 20 can support packet 32 traffic types such as but not limited; to periodic data: e.g. Sensor data, intermittent data that is generated on a periodic basis—e.g. Light switch traffic, and repetitive low latency data—e.g. mouse device traffic.

Referring again to FIG. 2, the network 20 is configured such that one or more controllers 13 form a personal area network 20. The controllers 13 can be subdivided into two different types of controllers, namely: a full functional controller 40 that can operate as either a coordinatorrouter andor a simple node of the network 20, can embody all the 802.15.4 functionality and features, can function in any network 20 topology, and can talk to any controller 13 in the network 20; and a reduced functional controller 42 that can operate as a simple node only (either source or destination), can function in a star topology only, and communicates only directly with the coordinator controller 41 and are found at the edge of the network 20. The full function controllers 40 use the resources of reduced function controllers 42 to self-organize into mesh, star, or tree network 20 topologies, by leveraging the ability to relay data packets 32 through nearby cooperating nodes. The full function controllers 40 used as a coordinator needs sufficient memory to hold the network 20 address configuration, data, and processing power to self-configure the network 20 in addition to its application task. The full function controllers 40 used as a router would store and forward packets 32 to and from controllers 42 that can't directly swap the packets 32. It is recognised that the coordinator or router function of the controller 40 could use more power than a simple controller 42 at the edge of the network 42 and may require line power or be powered from the associated device 12 with a power supply. The range per controller 13 on the local network 20 can be shorter than that of the gateways 18, in communication over the external network 14 (e.g. for example over the Internet), for example a nominal 10 m -100 m per controller 13 line of sight. The network 20 can employ 64-bit IEEE addresses and shorter 16-bit ones for local addressing on the network 20, as desired.

Network 20 Protocol Stack 300

Referring to FIG. 3, layers 306, 308 of the protocol stack 300 provide network structure, routing, security, discovery, and other network-level functions. The application layer 306 can be comprised of application-specific code incorporating hardware drivers for the controllers 13, including specifying the function of the controller 13 within the network 20 as well as the protocol for initiating and responding to events. For example, the controller 13 can be defined as the reduced function controller 42 or the full function controller 40. A further function of the application layer 306 can handle binding and discovery. The former involves matching controllers 13 based on how they're supposed to interact. For example, a light switch doesn't need to control a TV, but an audio-visual system remote can talk to the TV, a light dimmer, or a smoke alarm. The layer 306 can also relay messages from the controllers 13 that cannot communicate directly to each other, facilitating mesh networking of the controllers 13.

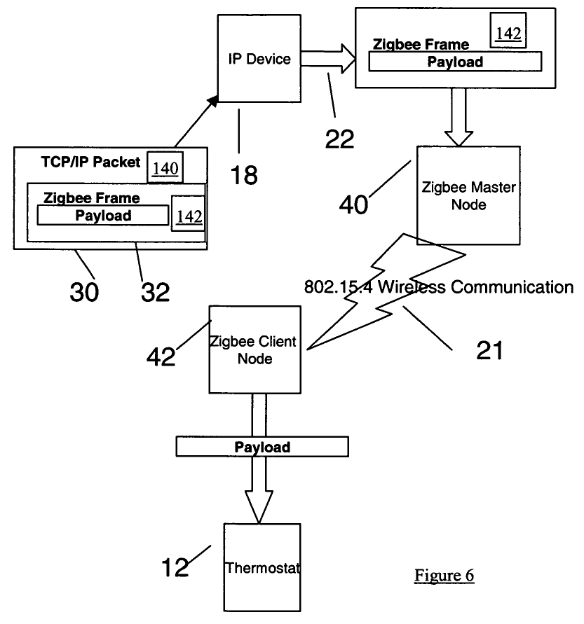

The protocol stack 300 can also have a network layer 308, such as but not limited to an LLC (Logical Link Control) that defines a data link protocol. The network layer 308 keeps track of controllers 13 joining and leaving the network 20. If the controller 13 is a coordinator 40, the network layer assigns a local address to the joining controller 13. If the coordinator 40 leaves, another full-function controller 13 can assume the deleted coordinator 13 role, as desired. Routing and security functions for frames can also be implemented at this layer 308. The protocol options may differ between the controllers 13, so the network layer 308 can be used to configure the protocol stack 300 appropriately. The MAC layer 302 (Media Access Control) layer is responsible for media control. The MAC layer 302 of the network 20 coordinates transceiver access to the shared radio link 21. The MAC layer 302 also schedules and routes data frames as packets 32 over the network 20, which are derived from the contents of the packets 30 received by the controller 40 from the gateway 18. The MAC layer 302 provides address generation and address recognition, and it verifies frame check sequences. The packet 32 types defined in 802.15.4, for example, are data frame (see FIG. 6), beacon, acknowledge, and MAC command. The MAC layer 302 provides functions like, such as but not limited to setEncryption, sendpacket, Scan, and so on. the function packetReceived is a typical callback finction.

The protocol stack 300 also has the PHY (physical) network layer 304. The network layer 304 is inside the modem and transceiver IC 300 (see FIG. 4). The physical layer 304 takes care of encoding bits to send and decoding received bits with a base-band modem and radio transceiver.

Gateway 18

Referring to FIG. 4, the gateway 18 can be a routernetwork 14 coordinator (e.g. device hardware andor software) that determines the next network pointaddress to which a communication packet 30 should be forwarded toward its destination on the selected network 20. The gateway 18 can have a computer 314 for any on-board software 102. The computer 314 includes a network connection interface 300, such as a wireless transceiver or a wired network interface card or a modem, coupled via connection 318 to a device infrastructure 304, for transmitting and receiving the packets 30. The computer 314 can also have a user interface 302 coupled to the device infrastructure 304 by connection 322 for facilitating in-person diagnostics by a technician, as compared to remote diagnostics done over the network 14 (e.g. between a user of the control server 26 and the gateway 18). The user interface 302 can include one or more user input devices such as but not limited to a QWERTY keyboard, a keypad, a stylus, a mouse, a microphone and the user output device such as an LCD screen display andor a speaker. If the screen is touch sensitive, then the display can also be used as the user input device as controlled by the device infrastructure 304. Operation of the computer 314 is enabled by the device infrastructure 304. The device infrastructure 304 includes a computer processor 308 and the associated memory module 316. The computer processor 308 manipulates the operation of the network interface 300, and if present the user interface 302, by executing related instructions provided by an operating system and the software 102 (e.g. located in the memory module 316). Further, it is recognized that the device infrastructure 304 can include a computer readable storage medium 312 coupled to the processor 308 for providing instructions to the processor andor to loadupdate the software 102 in the memory module 316. The computer readable medium 312 can include hardware andor software such as, by way of example only, magnetic disks, magnetic tape, optically readable medium such as CDDVD ROMS, and memory cards. In each case, the computer readable medium 312 may take the form of a small disk, floppy diskette, cassette, hard disk drive, solid state memory card, or RAM provided in the memory module 310. It should be noted that the above listed example computer readable mediums 312 can be used either alone or in combination.

Referring again to FIG. 4, the gateway memory 316 can hold informationdata such as but not limited to network 20 configuration information (e.g. number of, address, and communication format for each controller 13 linked to the gateway 18), device 12 data andor settings, controller 13 data andor settings, and configuration information to configuremonitor the network 20 in addition to relaying communicated data packets 30. In general terms, the gateway 18 is connected to at least two networks 14, 20 and decides which way to send each information packet 30 based on its current understanding of the state of the networks 14,20 the gateway 18 is connected to. The gateway 18 is located where one network 14 meets the network 20, including each point-of-presence on the Internet, for example. It is recognised that the gateway 18 can included as part of a network switch (not shown). Further, it is recognised that the gateway 18 may create or maintain a table 106 of the available controller 13 addresses for communicating a given packet 30. The contents of packet 30 may be converted into a packet 32 suitable for delivery and consumption by controllers 13 and devices 12 of the network 20. The gateway 18 can function as a full routing-capable node between the networks 14,20, as the gateway 18 maintains the comprehensive routing table 106 for the entire network that is updated based on user-defined intervals from the control server 26.

For example, the gateway 18 can be a network device such as but not limited to a router, an edge router that interfaces with an asynchronous transfer mode (ATM) network 14,20, a brouter that is a network bridge combined with a router, a server that provides services to other computer programs (and their users) such as in a clientserver programming model where the server is a programhardware that awaits and fulfills requests from client programshardware (e.g. the control server 26 , the controllers 13, etc . . . ). The gateway 18 may function as a client with requests for servicesdata (e.g. in the case where the packet 30 is communicated from the controller 13 with device data intended for the control server 26) and also as a server of requestsdata (e.g. in the case where the packet 30 is communicated from the control server 26 with configuration data status request intended for the controller 13 andor the eventual device 12).

In the case of the gateway 18 being a Web server, the gateway 18 is the computer program (in the memory 316) that serves requested HTML/XML pages or files containing datainformation relevant to the selected device 12 and controller 13 of the local device network 20. The network 14 would be the Internet or other widelocal area network using IP addressing between the gateway 18 and the Web client (i.e. the requesting program associated with the control server software 100—e.g. a web browser).

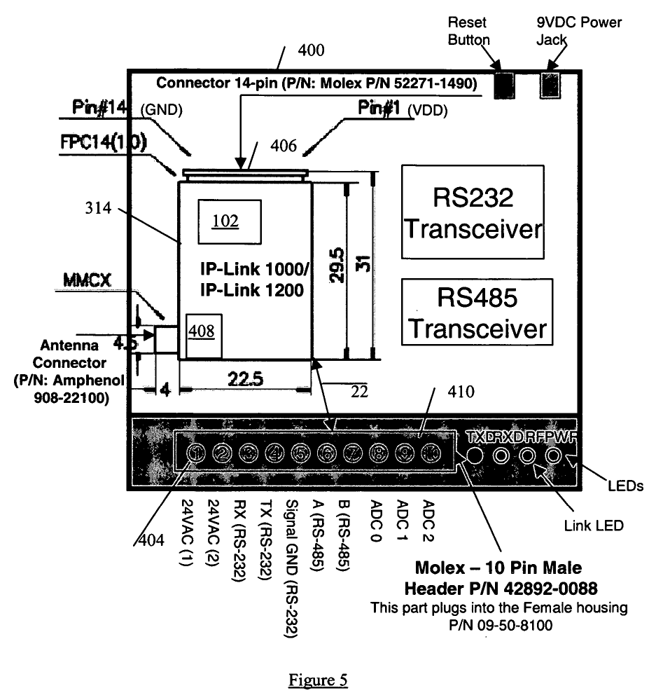

Referring to FIG. 5, an example embodiment of the gateway 18 includes a housing 400 for containing the computer 314 having the embedded software 102. The computer 314 is powered by a power supply 404. The network connection interface 300 (see FIG. 4) is provided as both a wired connector 406 and an RF transceiver 408 for connection to an antenna (not shown). Communication link 22 with the controller 40 (see FIG. 2) can be provided as a 3 channel, 10-bit AD conversion port 410 andor a serial port capable of supporting both RS232 and RS485 communication protocols via a multi-protocol enabled transceiver 412.

Referring again to FIG. 4, the software 102 can have a built-in Web Server 120 for communicating over the network 14 with the control server 26, such that the control server 26 would be configured as a client of the Server 120 of the gateway 18. The web server 120 would relay the following information from a control module 122 with respect to semi-automated control of the devices 12 (for example thermostats), information such as but not limited to:

1) General Thermostat Operation. These are functions monitored by a device operation module 130 by which the behaviour of the thermostat is controlled, i.e. turning the thermostat on and off, changing the mode of the thermostat, setting the temperature limits, etc;

2) Scheduled Thermostat Events. These are functions monitored by an Event scheduler module 132, by which thermostat events may be scheduled, i.e. having a thermostat function take place at a given time of day during a given day of the week; and

3) Monitor Thermostat Activities. These are functions monitored by an Activity module 134, by which data can be collected from thermostat readings, i.e. requesting the status of a thermostat, monitoring temperatures recorded by a thermostat over time, etc. Included in the monitoring functionality is the ability to set alerts on a device 12 and have the device 12 send an error message to the respective controller 13, which would then be responsible for coordinating the sending out of appropriate alert emails (e.g. through messaging via the gateway 18).

It is recognised that the software 102 has the control module 122 for performing the above listed functionality, such that the software 100 of the control server 26 could be used to programupdate or otherwise monitor the automatedsemi-automated functionality performed by the gateway 18 in communication with the controller 40, as required. For example, the software 100, under direction of a system administrator, could program the controller 122 and related modules 130,132,134 for subsequent independent monitoring of the device network 20, including such as but not limited to instructing the controllers 13 for control of the device 12 operation and receiving respective device 12 status, instructing the controllers 13 for scheduled events and receiving respective event status, and collecting data from the controllers 13 on the operation of the devices 12. Datainformation gathered from the devices 12 can be made available to the control server 26 via a report module 136 for collecting device 12 datainformation received from the network 20 in connection with the functionality of the modules 130,132,134. It is recognised that the gateway 18 could be: in communication with the full functional controller 42, which would then relay the communication to the respective reduced function controllers 42; in direct communication with the reduced function controllers 42; or a combination thereof. In the case of communication with the full function controllers 40, the gateway 18 could relay softwarecommand updates originating from the control server 26 andor could update or otherwise modify the programmed operation of the controller 40 based on feedback received by the modules 130,132,134. The gateway 18 also has a communication module 138 for formatting the packets 30,32 based on the table 106 contents, as further described below.

The control server software 100 would provide for communication requests and responses (using packets 30) with a plurality of the web servers 120 over the network 14 of different gateways 18. In this manner, device controlmonitoring of a plurality of local networks 20 and corresponding zones 16 spread out over a disparate geographical area (e.g. large hotels, hotel complexes, and national hotel chains) can be administered. Coupling of the local networks 20 via the gateway 18 to the network 14 provides for a desirable scalable control system 10 that can help overcome network 20 transmission and environmental restrictions.

Network 14 Addressing

Each of the gateways 18 on the wide area network 14 have an unique network 14 address for facilitating communication between the gateways 18 and control server 26 (or between gateways 18) on the wide area network 14 and eventually the devices 12 on the local area network 20 coupled to the respective controllers 13 that are connected to the gateway 18 having the unique network 14 address. For example, the network 14 address can be an IP address defined as such as but not limited to: 1) an Internet address or IP address that is a unique gateway 18 location on the network 14 expressed either as a unique string of numbers or as its associated domain name (e.g. example of an IP address expressed in dot notation: 205.999.172.99 or example of the domain name version: rigadev.com) and 2) a file (or home page) address expressed as the defining directory path to the file on a particular gateway 18 andor device 12/contoller 13 associated with the gateway 18. It is recognised that the Web page address can also be called a Uniform Resource Locator, or URL), for example http:www.rigadev.comgatewaygatewayl.html.

TCP/IP (Transmission Control ProtocolInternet Protocol) can be used as the basic communication language or protocol of the network 14. TCP/IP is a two-layer program. The higher layer, Transmission Control Protocol, manages the assembling of a message or file into smaller packets that are transmitted over the Internet 14 and received by a TCP layer that reassembles the packets 30 into the original message. The lower layer, Internet Protocol, handles the address part of each packet so that it gets to the right destination, i.e. the gateways 18. Even though some packets 30 from the same message are routed differently than others, they are reassembled at the destination (e.g. gateway 18).

The IP address can be defined as an identifier for the gateway 18 (and control server 26 if applicable) on the TCPIP network 14. Networks using the TCP/IP protocol route messagespackets 30 based on the IP address of the destination. The format of an IP address is a 32-bit numeric address written as four numbers separated by periods (e.g. each IP address number can be zero to 255 known as octets separated by decimal points—known as dotted decimal notation) that identifies each sender or receiver of information that is sent in packets 30 across the network 14. When the packet 30 is communicated, the Internet Protocol part of TCPIP includes the destination IP address in the message (actually, in each of the packets 30 if more than one is required) and sends it to the IP address that is obtained by looking up the domain name in the Uniform Resource Locator requested. At the other end, the recipient can identify the IP address of the requestor and can respond across the network by sending another messagepacket using the IP address it received.

For example, 1.160.10.240 could be an IP address. The IP address is usually expressed as four decimal numbers, each representing eight bits, separated by periods. This is sometimes known as the dot address and, more technically, as dotted quad notation. For Class A IP addresses, the numbers would represent “network.local.local.local”; for a Class C IP address, they would represent “network.network.network.local”. The number version of the IP address can (and usually is) represented by a name or series of names called the domain name.

An IP address has two parts: the identifier of a particular network on the network 14 and an identifier of the particular node (i.e. gateway 18) within that network 14. On the network itself—that is, between a router that move packets 30 from one point to another along the route -only the network part of the address is looked at. The class of the address and the subnet mask determine which part belongs to the network address and which part belongs to the node address.

The Network Part of the IP Address

The network 14 can be an interconnection of many individual networks. So the Internet Protocol (IP) is basically the set of rules for one network communicating with any other (or occasionally, for broadcast messages, all other networks). Each network 14 must know its own address and that of any other networks with which it communicates. To be part of the Internet (e.g. network 14), for example, an organization needs an Internet network 14 number that is included in any packet sent out of the network 14 onto the Internet.

The Local or Host Part of the IP Address

In addition to the network 14 address or number, information is needed about which specific machine or host (e.g. the gateway 18) in the network 14 is sending or receiving the packets 30. So the IP address uses both the unique network number and a host number (which is unique within the network 14). The host number is sometimes called a local or machine address. Part of the local address can identify a subnetwork or subnet address, which makes it easier for a network that is divided into several physical subnetworks (for examples, several different local area networks 20) or to handle many devices 12 and respective controllers 13.

In the following example of an IP address, 140.179.220.200 is a Class B address so by default the Network 14 part of the address (also known as the Network Address) is defined by the first two octets (140.179.x.x) and the node part (gateway 18) is defined by the last 2 octets (x.x.220.200). In order to specify the network address for a given IP address, the node section is set to all “0”s. In this example, 140.179.0.0 specifies the network 14 address for 140.179.220.200. When the node section is set to all “1”s, it specifies a broadcast that is sent to all hosts (gateways 18) on the network 14. Accordingly, 140.179.255.255 specifies the example broadcast address.

IP Address Classes and their Formats

Since networks 14 vary in size, there are four different address formats or classes that are currently used when using a network number: Class A addresses are for large networks with many devices; Class B addresses are for medium-sized networks; Class C addresses are for small networks (fewer than 256 devices); and Class D addresses are multicast addresses. The first few bits of each IP address indicate which of the address class formats it is using. The address structures look like this: Class A—0. Network (7 bits). Local address (24 bits); Class B—10. Network (14 bits). Local address (16 bits); Class C—110. Network (21 bits). Local address (8 bits); and Class D—1110. Multicast address (28 bits).

Relationship of the IP Address to the Physical Address

The machine or physical address used within an organization's local area networks 20 may be different than the Internet's IP address. The most typical example is the 48-bit Ethernet address. Ethernet is the most widely-installed local area network 20 (LAN) technology, specified in the standard, IEEE 802.3. TCPIP can use an Address Resolution Protocol (ARP) that lets an administrator of the local network 20 create the table 106 (see FIG. 1) that maps IP addresses of the network 14 to physical addresses used in the network(s) 20.

Private Subnets

Within an isolated network 20, for example, IP addresses can be assigned at random as long as each one is unique. However, connecting a private network 20 to the Internet 14 requires using registered IP addresses (called Internet addresses) to avoid duplicates. For example, there are three IP network addresses reserved for privatelocal networks 20. The addresses are 10.0.0.0/8, 172.16.0.0/12, and 192.168.0.0/16. These addresses can be used for setting up internal IP local networks 20, where desired, behind a NAT or proxy server or a router (e.g. which can be part of the gateway 18). Routers on the Internet 14 do not forward packets coming from these privatelocal network 20 addresses. Private subnets can be used in the control system 10, since in general in an Ethernet network 14, all nodes on a segment see all the packets 30 transmitted by all the other nodes on that segment. Performance can be adversely affected under heavy traffic loads, due to collisions and the resulting retransmissions. The router of the gateway 18 can be used to connect the local networks 20 to the IP network 14 to minimize the amount of traffic each segment receives. In operation, applying a subnet mask to an IP address allows the identification of the network and node parts of the address. The network bits are represented by the 1s in the mask, and the node bits are represented by the 0s. Performing a bitwise logical AND operation between the IP address and the subnet mask results in the Network Address or Number.

TCP/IP and the higher-level applications that use it are collectively said to be “stateless” because each client request is considered a new request unrelated to any previous one (unlike ordinary phone conversations that require a dedicated connection for the call duration). Being stateless frees network paths so that everyone can use them continuously. (Note that the TCP layer itself is not stateless as far as any one message is concerned. Its connection remains in place until all packets in a message have been received. TCP/IP includes protocols such as the World Wide Web's Hypertext Transfer Protocol (HTTP), the File Transfer Protocol (FTP), Telnet (Telnet) which lets you logon to remote computers, and the Simple Mail Transfer Protocol (SMTP). These and other protocols are often packaged together with TCP/IP as a “suite.” Personal computer users usually get to the Internet 14 through the Serial Line Internet Protocol (SLIP) or the Point-to-Point Protocol (PPP). These protocols encapsulate the IP packets so that they can be sent over a dial-up phone connection to an access provider's modem. Protocols related to TCP/IP include the User Datagram Protocol (UDP), which is used instead of TCP for special purposes. Other protocols are used by network host computers for exchanging router information. These include the Internet Control Message Protocol (ICMP), the Interior Gateway Protocol (IGP), the Exterior Gateway Protocol (EGP), and the Border Gateway Protocol (BGP).

User Datagram Protocol

In addition to the above, it is recognised that the network 14 address could be a UDP based address, a connectionless protocol that, like TCP, runs on top of IP networks 14. Unlike TCP/IP, UDP/IP provides few error recovery services, offering instead a direct way to send and receive datagrams over the IP network 14, used for such as broadcast messages over the network 14. In general, User Datagram Protocol makes available a datagram mode of packet 30—switched computer communication in the environment of an interconnected set of computer networks 14. The UDP/IP protocol assumes that the Internet Protocol (IP) [1] is used as the underlying protocol. This protocol provides a procedure for application programs to send messages to other programs with a minimum of protocol mechanism. The UDP/IP protocol is transaction oriented, and delivery and duplicate protection are not guaranteed. Applications requiring ordered reliable delivery of streams of data typically use the Transmission Control Protocol (TCP)

Packet 30,32 Characteristics

Referring to FIGS. 1 and 6, the packets 30,32 used on the networks 14,20 are the unit of data that is routed between an origin and a destination on the Internet 14 or any other packet-switched network 20. For example, when any filedata (e-mail message, HTML file, Graphics Interchange Format file, Uniform Resource Locator request, and so forth) is sent from one place to another on the Internet 14, the Transmission Control Protocol (TCP) layer of TCP/IP divides the file into “chunks” of an efficient size for routing. Each of these packets 30 is separately numbered and includes the Internet 14 address of the destination (e.g. control server 26 or gateway 18). The individual packets 30 for a given file may travel different routes through the Internet 14. When they have all arrived, they are reassembled into the original file (by the TCP layer at the receiving end).

A packet-switching scheme is an efficient way to handle transmissions on a connectionless network such as the Internet 14. An alternative scheme, circuit-switched, is used for networks allocated for voice connections. In circuit-switching, lines in the network are shared among many users as with packet-switching, but each connection requires the dedication of a particular path for the duration of the connection. “Packet” and “datagram” are similar in meaning. A protocol similar to TCP, the User Datagram Protocol (UDP) uses the term datagram.

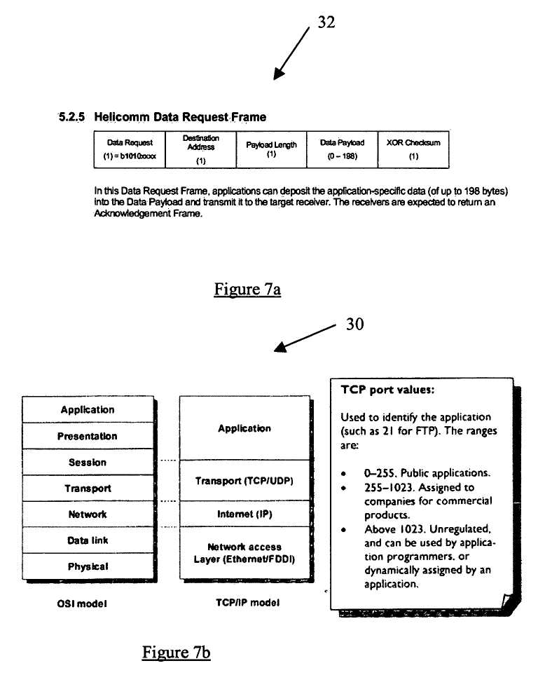

Referring again to FIG. 6, packet 30,32 architecture used over the networks 14,20 involves embedding of packet 32 in packet 30, as well as operation of the communication module 138 of the gateway 18 to assemble and disassemble the packets 30, to accommodate communication between the Zigbee network 20 and the IP network 14. For example, for communication from the server 26 to the device 12, the control server 26 sends the payload (e.g. data intended for device 12) to the IP device (i.e. gateway 18) wrapped first in a Zigbee frame (example packet 32 format shown in FIG. 7a) and then inside of the TCP/IP Packet 30 (example shown in FIG. 7b). An appropriate address 140 of the gateway 18 (e.g. unique IP address) is determined by the communication module 90 of the software 100 based on the contents of the table 98 (e.g. matches the hotel room number to the assigned device 12, controller(s) 40,42, and respective gateway 18). The address 140 of the gateway 18 is inserted into the packet 30 while an address 142 (e.g. unique local network 20 address but may not be unique for addressing purposes of the network 14) of the controller(s) 40,42 is inserted into the packet 32. The packet 30 travels over the network 14 and arrives at gateway 18 where the TCP/IP is stripped away by the communication module 138 and the remaining Zigbee Frame and payload is sent to the addressed controller 40 (of the address 142) via serial either RS-232 or RS-485, as packet 32. If needed, from the controller 40 the payload is sent via 21 until it reaches to the addressed client controller 42. The client controller 42 then sends the payload via serial to the thermostat device 12.

In view of the above, it is recognised that the reverse procedure of sending collected data from the device 12 to the control server 26 could involve, the communication module 90 of the gateway 18 assembling the packet 30 to include the Zigbee packet 32 and including addressing 140,142 as described above.

Example Operation of the Control System 10

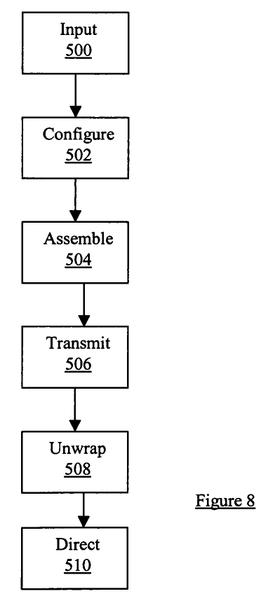

Referring to FIGS. 1 and 8, the control system 10 demonstrates the Control Server 26 utilizing the Hotel Reservation System 28 to determine individual thermostat 12 control.

Once a wireless controlled network 20 of thermostats 12 has been installed in a Hotel environment (e.g. zones 16), the input 500 from the existing Hotel reservation system 28 is used by the software 100 to help controlconfigure 502 the thermostats 12 and maximize efficiency and power savings. The software 100 assembles 506 the packet 30 and then transmits 508 the packet 30 over the network 14. the gateway 18 unwraps 508 the packet 30 and then prepares the packet 32 for transmission 510 to the appropriate controller 13 with coupled device 12. The control server 26 in conjunction with the addressable gateways 18 will control operation of the thermostats 12 based on a set of customizable business logic that is shared between the softwares 100,102.

For example, the software 100 will first determine whether a room in a particular zone 16 is booked or vacant. When a room is vacant the thermostat 12 will be given a predefined temperature to maintain the room at, whereby the software 100 relays the required temperatureroom information to the control software 102 of the gateway 18 over the network 14. This temperature can be determined in one of two ways, for example. The first will be to assess the outside ambient temperature and allow the room to hover around that temperature, within a defined safety limit. A safety limit will be determined for each site and is configured into each site. The second method will be to store a target temperature for each month of the year. The target temperatures will be verified to ensure they are not outside of the defined safety range.

Further, the software 102 can also be programmed to aid in the preventative maintenance of the HVAC systems in the hotel or possibly commercialindustrial building. The software 102 can, at predefined intervals raise and lower the temperature in the rooms or offices, by instructing the respective controllers 13 of the selected thermostats 12. The amount of time required to raise or lower the temperature will be recorded. This time will be used to determine when an HVAC unit is either malfunctioning or failing to perform within predefined specifications. This gathered operation information of the thermostats can be relayed back to the software 100 of the control server 26 through the web server 120 in either a synchronous andor asynchronous manner. With this information building managers can perform preventative maintenance during business hours when labour rates are cheaper. In addition, preventative maintenance can allow Hotel managers to keep more rooms available for guests and fewer rooms will have to be taken out of use.

It is recognised that some or all of the above described software 100,102 flnctionality could be provided by suitable hardware based modules (not shown), as desired. Further, it is recognised that the control server 26 can interact with management systems 28 other than hotel management system, as desired. Further, it is recognised that the gateway 18 and the control server 26 can actually be all hosted on the same device connected to the network 14 (the server 26 and the gateway 18 can be the same logically andor physically, modules and devices respectively), such that the Rigabox 18 can provide all the functionality that the server 26 can provide, e.g. sending out commands to devices 12, sending out alert emails, monitoring the status of networks, etc. . .

The embodiments of the invention in which an exclusive property: or privilege is claimed are defined as the follows:

1. A system for remote monitoring via an external network of the operation of a plurality of devices located on a local area network, the system comprising:
a gateway module for coupling the external network with the local area network, the gateway module having a unique external network address and configured for receiving a network data packet addressed by the external network address, the gateway module configured for extracting a device data packet from the network data packet and for sending the device data packet to an associated local network address on the local area network;
a control server configured for coupling to the gateway module and configured for generating the network data packet to contain the device data packet associated with a selected device of the plurality of devices, such that the local network address is associated with the selected device; and
a controller module addressable on the local area network and coupled to the selected device, the controller module for receiving the device data packet according to the local network address and configured for operating the selected device according to the contents of the device data packet.

2. The system of claim 1 further comprising a management server coupled to the control server, the management server having at least one of; status information concerning usage of a physical location of the selected device; and information on services associated with the physical location.

3. The system of claim 2, wherein the physical location is a hotel room.

4. The system of claim 2, wherein the services are selected from the group comprising: an occupancy schedule of the physical location; and historical operational data of the selected device.

5. The system of claim 2 further comprising a communication module of the control server for generating the network data packets to contain the external network address of the gateway, the device data packet, and data for controlling the operational behaviour of the selected device.

6. The system of claim 5 further comprising a configuration module of the control server for accessing the management server to collect information on the selected device the information including at least one of the physical location and the services information.

7. The system of claim 6 further comprising a control module including business logic for operation of the selected device, the control module configured for using the collected information for determining the data contents of the device data packet.

8. The system of claim 7 further comprising an address table coupled to the communication module, the address table containing the external network address and the local network address associated with the selected device.

9. The system of claim 8, wherein the address table contains respective external network addresses and the local network addresses associated with each of the plurality of devices.

10. The system of claim 5 further comprising an address table coupled to the communication module, the address table containing the external network address and the local network address associated with the selected device.

11. The system of claim 10, wherein the communication protocol of the external network is different from that of the local area network.

12. The system of claim 11, wherein the external network is the Internet.

13. The system of claim 10, wherein the local area network is a wireless based network.

14. The system of claim 13, wherein the communication protocol of the local area network is configured for low data rate communications between 20 and 250 kbps.

15. The system of claim 13, wherein the device data packet is configured for periodic data content.

16. The system of claim 15, wherein the periodic data content is selected from the group comprising: switch data; repetitive low latency data; and sensor data.

17. The system of claim 2 further comprising the gateway module coupled to an address table containing a number of the controllers, the local network address of the controllers, and the communication format of the controllers, such that gateway module is configured for determining the local network address of the controller associated with the selected device using the contents of the network data packet and the address table.

18. The system of claim 2 further comprising a web server resident on the gateway module, the web server for communicating asynchronously or synchronously with the control server over the external network.

19. The system of claim 2 further comprising an operation module of the gateway module for controlling the operational behaviour of the selected device.

20. The system of claim 19 further comprising a schedule module of the gateway module for coordinating scheduling of the operational behaviour of the selected device.

21. The system of claim 20 further comprising an activity module of the gateway module for monitoring the selected device behaviour.

22. The system of claim 21 further comprising a report module of the gateway module for collecting selected device data from at least one of the operation module, schedule module, or activity module and configured for communicating the collected selected device data to the control server.

23. The system of claim 22, wherein interaction of the gateway module with the selected device is selected from the group comprising active control and passive monitoring.

24. The system of claim 2, wherein the controller module is selected from the group comprising a coordinator node of the local area network and a destination node of the local area network.

25. The system of claim 24, wherein the local network address is for the coordinator node which is coupled to the destination node connected to the selected device.

26. The system of claim 9, wherein the device is selected from the group comprising: environmental monitoring instruments; medical and building monitoring instruments, sensors for measuring temperature andor heat flow; switches for electronic devices; stress/strain sensors; relay controls; and motion sensors.

27. The system of claim 26, wherein the data contents of the device data packet are selected from the group comprising: sensor readings; configuration data for the controller; configuration data for the selected device; diagnostic data of the selected device; diagnostic data of the controller; and control software for the controller.

28. The system of claim 13, wherein the communication protocol of the local area network is selected from the group comprising: Zigbee 900 MHz and 2.4 GHz (IEEE 802.15.4), Wi-Fi (IEEE 802.11b/g), Wired Ethernet (IEEE 802.3), RS-232, and RS-485.

29. The system of claim 12, wherein the external network address is selected from the group comprising: an IP address that is a unique location on the external network 14 expressed either as a unique string of numbers or as its associated domain name; a file address expressed as a defining directory path to the file; and a web page address.

30. A system for remote monitoring via an external network of the operation of a plurality of devices located on a local area network, the system comprising:
a control server having a unique external network address and configured for processing a received network data packet that contains a device data packet associated with a selected device of the plurality of devices;
a gateway module configured for coupling to the control server via the external network, the gateway device for coupling the external network with the local area network, the gateway module configured for sending the network data packet to the external network address, the gateway module configured for adding the device data packet to the network data packet prior to sending the network data packet such that the device data packet is associated with a local network address on the local area network, the local network address associated with the selected device; and
a controller module addressable on the local area network and configured for coupling to the selected device, the controller for sending the device data packet including the local network address to the gateway device.

31. A method for remote monitoring via an external network of the operation of a plurality of devices located on a local area network, the system comprising:
generating a network data packet to contain a device data packet associated with a selected device of the plurality of devices, the network data packet including a unique external network address of a gateway module located on the external network and a local network address associated with the selected device; and
sending the network data packet to the gateway module, the gateway module for coupling the external network with the local area network, the network data packet configured for providing the local network address for use by the gateway module for forwarding the device data packet to the selected device.

32. The method of claim 31 further comprising the step of a controller module receiving the device data packet according to the local network address and configured for operating the selected device according to the contents of the device data packet, the controller module addressable on the local area network and coupled to the selected device.

33. The method of claim 31 further comprising the step of accessing at least one of; status information concerning usage of a physical location of the selected device; and information on services associated with the physical location, the information for use in determining the contents of the device data packet.

34. The system of claim 2, wherein the control server and the gateway module are hosted on respective devices connected to the networks.

35. The system of claim 2, wherein the control server and gateway module are hosted on the same device, such that the external network address is shared by the control server and gateway module.
